(19) United States
(12) Patent Application Publication
(10) Pub. No.: US 2026/0070072 A1
(43) Pub. Date: Mar. 12, 2026

(54) CONVERGING COMBINATION SHOWERHEAD

(71) Applicant: Delta Faucet Company, Indianapolis, IN (US)

(72) Inventors: David Lee, Westfield, IN (US); Xiongbo Fu, Carmel, IN (US)

(21) Appl. No.: 19/320,628

(22) Filed: Sep. 5, 2025

Related U.S. Application Data
(60) Provisional application No. 63/691,687, filed on Sep. 6, 2024.

(51) Int. Cl. B05B 1/18; E03C 1/04

(52) U.S. Cl. CPC B05B 1/1825; E03C 1/0408

(57) ABSTRACT

A shower assembly includes a base showerhead including a plurality of outlets and defining a longitudinal axis. Each of the outlets ejects a liquid in a respective direction at a respective angle relative to the longitudinal axis. A handheld shower is removably coupled to the base showerhead. When the handheld shower is removed from the base showerhead, the outlets of the base showerhead pivot.

### CROSS-REFERENCE TO RELATED APPLICATION

The present invention claims priority to U.S. Provisional Patent Application Ser. No. 63/691,687, filed Sep. 6, 2024, the disclosure of which is expressly incorporated herein by reference.

### BACKGROUND AND SUMMARY OF THE INVENTION

The present invention relates generally to a showerhead. Specifically, the present invention relates to a dual showerhead including a removable handheld portion.

An illustrative shower assembly of the present disclosure may provide a fixed showerhead including a releasably coupled handshower (also referred to as a handheld shower), where outlets of the fixed showerhead and/or the handshower are moved in response to uncoupling of the handshower. Illustratively, the outlets of the showerhead may be directed to the opening remaining when the handshower is removed. A common complaint about many 2-in-1 combination showerheads is that when the fixed showerhead and removable handshower (e.g., external and internal showerheads) are separated, the fixed showerhead may have a hole of spray coverage on the user.

Conventional means to reduce this effect may include permanently positioning (e.g., angleing) the spray trajectory of the external showerhead inward, thereby filling in the gap that is left when the external showerhead and the internal handshower are separated. However, a trade off exists as the coverage in the combined position results in higher density in the center of the spray, with both the internal handshower and the external showerhead being directed toward the center of the spray, but with lower density on the outer ring of the spray.

The illustrative shower assembly of the present disclosure may provide a means to more evenly distribute the density of coverage regardless of whether the fixed (e.g., external) showerhead and the moveable (e.g., internal) handshower are in separated (undocked) or combined (docked) positions. According to an illustrative embodiment, the shower assembly may achieve such even distribution in both positions by adjusting the spray trajectory of the showerhead when the handshower is removed (undocked) from the showerhead, and adjusting the spray trajectory again when the handshower is reunited (docked) with the showerhead. One exemplary way the shower assembly of the present disclosure might solve the above problem is by adjusting the showerhead sprays inwards to close the gap that is left behind once the handshower is separated (undocked) from the showerhead.

The adjustment of the spray trajectory may be accomplished by the user manually moving nozzles in unison by mechanical linkage. The adjustment of the spray trajectory may alternatively be accomplished by an automatic means through sprays that are biased inwards (or outwards) and cammed to move outwards (or inwards) when the handshower is combined with the showerhead. In an illustrative embodiment, each segment of the showerhead is biased towards the inside when the handshower is removed. However, it is also possible to move only smaller outlet components that eject water. Such water-ejecting outlets may include nozzles and/or fluidic chips, also known as microfluidic chips or lab-on-a-chip devices.

According to an illustrative embodiment of the present disclosure, a shower assembly includes an external showerhead having a plurality of sections. Each section includes a faceplate having a plurality of outlets. The sections define a central gap therebetween and define a longitudinal axis. Each of the outlets ejects a liquid in a respective direction at a respective angle relative to the longitudinal axis. A handheld shower is removably coupled to the external showerhead in the central gap. A plurality of springs are configured to bias the sections of the external showerhead against the handheld shower, such that when the handheld shower is removed from the external showerhead, each of the sections of the external showerhead pivot relative to the central gap. Illustratively, when the handheld shower is removed from the external showerhead, the angles between the longitudinal axis and the directions in which the outlets of the external showerhead eject the liquid increase.

According to another illustrative embodiment of the present disclosure, a shower assembly includes a base showerhead including a plurality of outlets and defining a longitudinal axis. Each of the outlets is configured to eject a liquid in a respective direction at a respective angle relative to the longitudinal axis. A handheld shower is removably coupled to the base showerhead. Illustratively, the outlets of the base showerhead are configured to pivot relative to the longitudinal axis in response to uncoupling of the handheld shower from the base showerhead.

According to a further illustrative embodiment of the present disclosure, a shower assembly includes a substantially annular external showerhead including a plurality of sections, each having a plurality of outlets. The sections define a central gap therebetween. The outlets are configured to eject a liquid in first directions. A handheld shower is removably coupled to the external showerhead in the central gap. A plurality of biasing members bias the sections of the external showerhead against the handheld shower such that when the handheld shower is removed from the external showerhead, each of the sections of the external showerhead pivot such that the outlets eject the liquid in second directions. The second directions are more inward than the first directions relative to the central gap.

According to a further illustrative embodiment of the present disclosure, a shower assembly includes a base showerhead having a plurality of outlets. The base showerhead defines a receiver and a longitudinal axis. A handheld shower is removably coupled to the base showerhead in the receiver in a first mode. Each of the outlets in the first mode is configured to discharge a liquid in a first direction at a first angle relative to the longitudinal axis. The outlets are biased toward the receiver when the handheld shower is removed from the base showerhead in a second mode, such that each of the outlets discharge the liquid in a second direction at a second angle relative to the longitudinal axis.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a front perspective view of a converging combination showerhead according to an illustrative embodiment of the present invention.

FIG. 2 is a partially exploded front perspective view of the converging combination showerhead of FIG. 1, showing the handshower removed from the external showerhead.

FIG. 3 is a rear perspective view of the external showerhead of FIG. 2.

FIG. 4 is a cross-sectional view of the external showerhead of FIG. 3 along line 4-4.

FIG. 5 is a cross-sectional view of the external showerhead of FIG. 3 along line 5-5.

FIG. 6 is a partially exploded rear perspective view of the external showerhead of FIG. 2, showing the cap removed from the external showerhead.

FIG. 7 is an exploded rear perspective view of the external showerhead of FIG. 6.

FIG. 8 is an exploded front perspective view of the external showerhead of FIG. 6.

FIG. 9 is a cross-sectional view of one segment of the external showerhead of FIG. 3 along line 9-9 in a first position with the handshower docked in the external showerhead.

FIG. 10 is a cross-sectional view of one segment of the external showerhead of FIG. 3 along line 9-9 in a second position with the handshower undocked and removed from the external showerhead.

FIG. 11 is a rear view of one of the spokes and fragments of the hub and of one of the segments of the external showerhead of FIG. 3.

FIG. 12 is a front perspective view of the converging combination showerhead of FIG. 1 and a diagram of its spray coverage.

FIG. 13 is a front perspective view of the external showerhead of the converging combination showerhead of FIG. 1, showing its spray coverage would be if it were not able to tilt inward as enabled by the present invention.

FIG. 14 is a front perspective view of the external showerhead of the converging combination showerhead of FIG. 1, showing its spray coverage when tilted inward as enabled by the present invention.

FIG. 15 is a front perspective view of one of the manifolds of the external showerhead of FIG. 3.

FIG. 16 is a front perspective partially fragmentary view of the manifold of FIG. 15.

FIG. 17 is a cross-sectional view of one segment of a further illustrative external showerhead similar to FIG. 9 in a first position with the handshower docked in the external showerhead.

FIG. 18 is a cross-sectional view of one segment of the external showerhead of FIG. 17 in a second position with the handshower undocked and removed from the external showerhead.

FIG. 19 is a cross-sectional view of one segment of the external showerhead of FIG. 17 in a third position with the handshower undocked and removed from the external showerhead.

FIG. 20 is a diagrammatic view of an illustrative converging combination showerhead including a handshower removably docked within a central opening of a base showerhead.

FIG. 21 is a diagrammatic view of another illustrative converging combination showerhead including a handshower having a central opening removably docked with a base showerhead.

FIG. 22 is a diagrammatic view of a further illustrative converging combination showerhead including a handshower removably docked with a vertically aligned base showerhead.

FIG. 23 is a diagrammatic view of another illustrative converging combination showerhead including a handshower removably docked with a horizontally aligned base showerhead.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

The embodiments of the disclosure described herein are not intended to be exhaustive or to limit the disclosure to the precise forms disclosed. Rather, the embodiments described herein enable one skilled in the art to practice the disclosure.

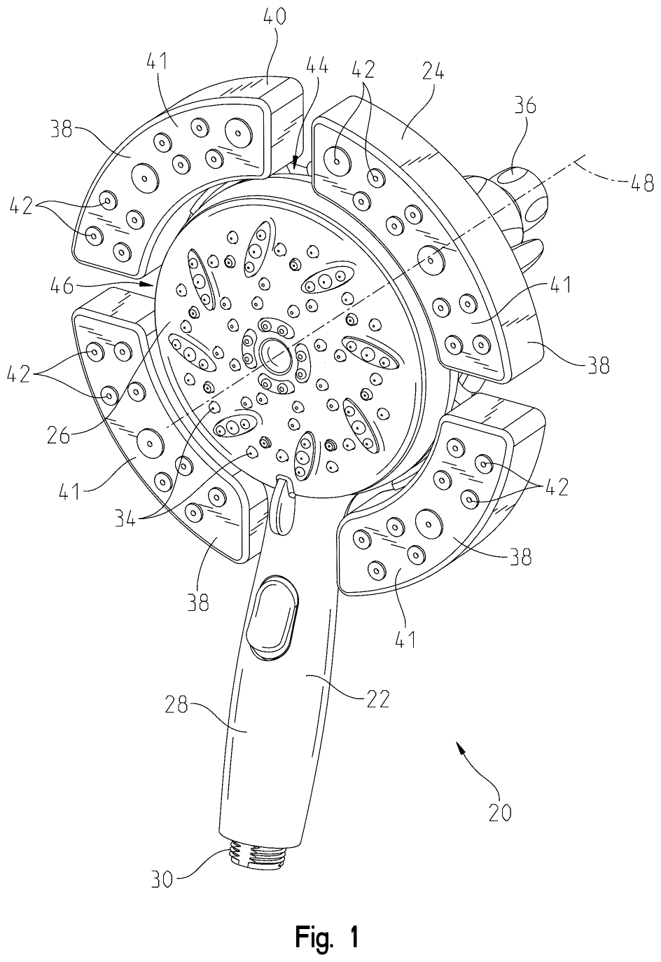

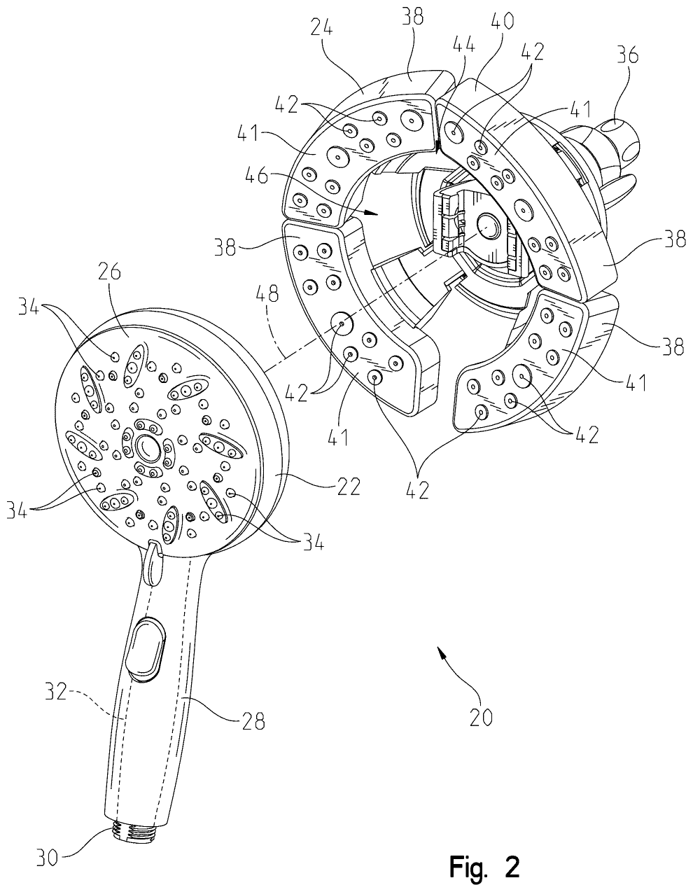

Referring initially to FIG. 1, a converging combination showerhead or shower assembly 20 (also referred to as a fixed or base showerhead) is shown as including a handheld shower or internal handshower 22 (also referred to as a moveable handshower) removably docked in a base or external showerhead 24 according to one illustrative embodiment of the present disclosure. Illustrative handshower 22 includes a head portion 26 and a handle 28. Handle 28 includes a water inlet 30 and an internal conduit 32 (FIG. 2) that carries pressurized water to water outlets 34 (e.g., nozzles) of head portion 26 such that nozzles 34 may discharge or eject the water, as is conventionally known.

The illustrative handshower 22 is movable relative to the external showerhead 24 from a first or docked mode (FIG. 1) and a second or undocked mode (FIG. 2). According to certain illustrative embodiments, the handshower 22 is internal and the showerhead 24 is external when the handshower 22 is docked with the showerhead 24. Illustrative shower assemblies including a handshower removably coupled to an external showerhead are detailed in U.S. Pat. No. 7,900,295 to Lev, U.S. Pat. No. 9,149,817 to Lev, and U.S. Pat. No. 10,017,923 to Genord et al., the disclosures of which are expressly incorporated herein by reference.

External showerhead 24 illustratively includes a water inlet 36 through which pressurized water enters showerhead 24 and is carried to four segments or sections 38 of showerhead 24. The segments 38 are circumferentially spaced to form an annular ring 40. As may be appreciated, the number and placement of the segments 38 may vary. Each of segments 38 includes a faceplate 44 having water outlets 42 in the form of nozzles that may discharge or eject the pressurized water. Illustratively, segments 38 are circumferentially spaced around a receiver 44, illustratively defined by a center gap or opening 46 having a longitudinal axis 48, and configured to receive head portion 26 of handshower 22 in the docked mode (FIG. 1).

As further detailed herein, other illustrative embodiments may include an external handshower removably coupled to an internal showerhead. For example, segments 38 may be positioned internal to the handshower 22. As such, the segments 38 define receiver or opening 46 external to the center of showerhead 24 for receiving the handshower 22 (which may be an annular ring, for example, supporting nozzles 34).

In an illustrative embodiment, a user may manually pivot segments 38 relative to opening 46. In other illustrative embodiments, segments 38 may be biased via a biasing member (e.g., a spring) inwardly toward opening 46. While springs may be used to bias the segments 38, other biasing means may be substituted therefore, such as elastics, magnets, air pressure, water pressure and/or electric actuators. Alternatively, the segments 38 may be manually moved by a user.

As seen in a comparison of FIGS. 1 and 9 to FIGS. 2 and 10, when handshower 22 is removed or undocked from external showerhead 24, each segment 38 of showerhead 24 tilts or pivots such that nozzles 42 also tilt or pivot. More particularly, according to the illustrative embodiment, the nozzles 42 move from a first angle (α1) relative to the longitudinal axis 48, to a second angle (α2) relative to the longitudinal axis 48 such that the nozzles 42 face and are directly more inwardly. Thus, the water spray from nozzles 42 may fill in the central gap in spray coverage that results when handshower 22 is removed.

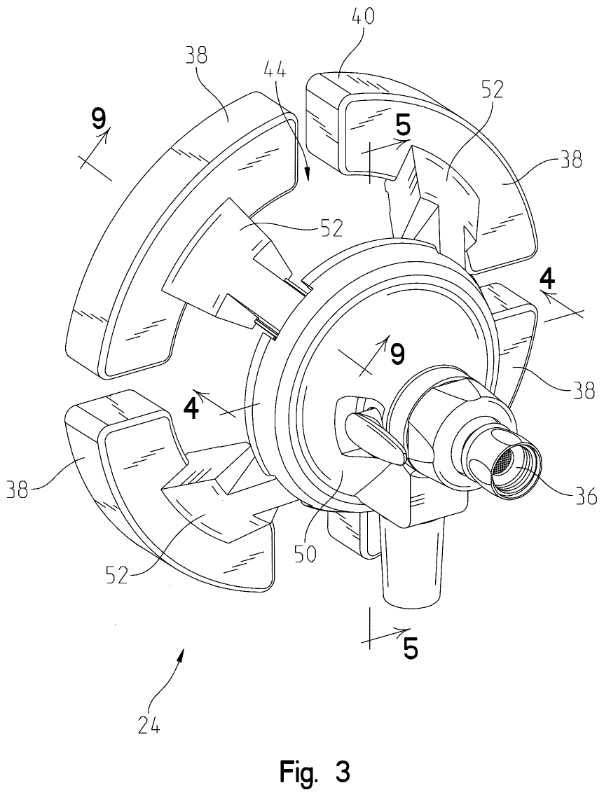

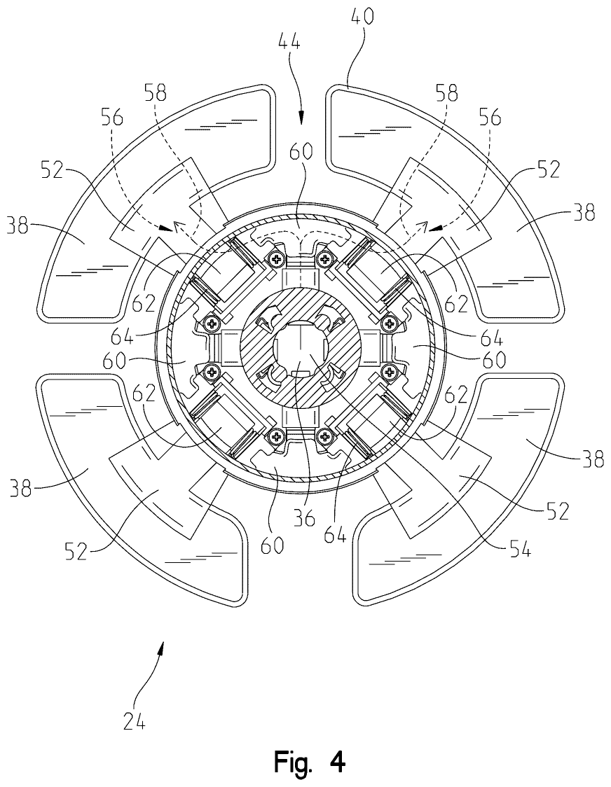

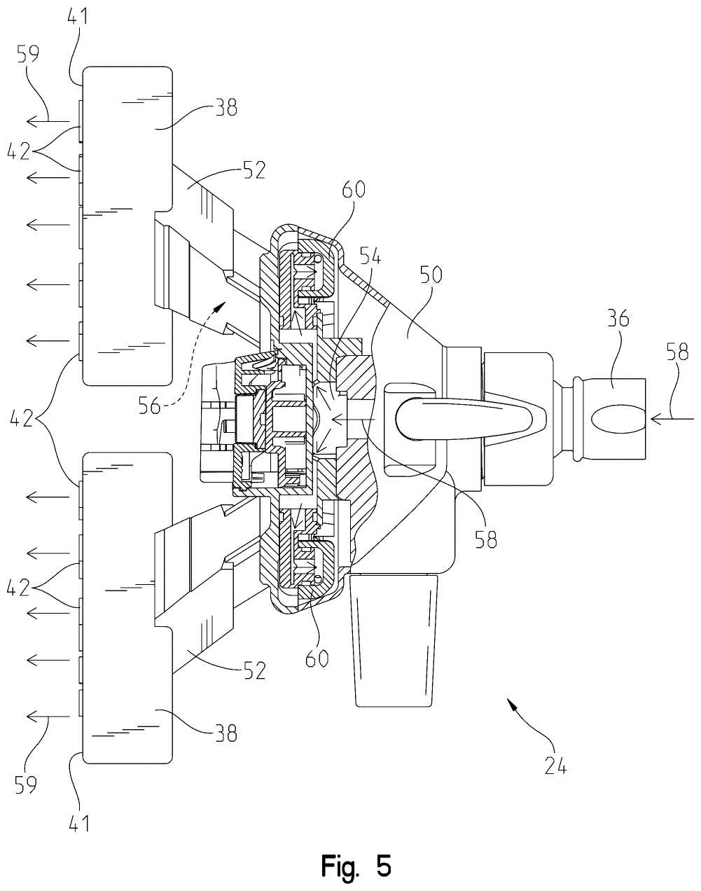

As shown in FIG. 3, each segment 38 of showerhead 24 is illustratively attached to a hub 50 of showerhead 24 by a respective arm or spoke 52. Conduits 54 and 56 within hub 50 and spokes 52 carry water from water inlet 36 to segments 38 (FIGS. 4 and 5).

FIGS. 4 and 5 illustrate the paths 58 of water from inlet 36 to each of the four segments 38. Water flows from inlet 36 to each of four manifolds 60. From each manifold 60, the water is directed to both of two adjacent spokes 52 and then to two adjacent segments 38. Thus, each segment 38 receives water from two adjacent manifolds 60.

At the opposite ends of each base 62 of each spoke 52 is a respective biasing member, such as a coil spring 64, as best shown in FIG. 11. Coil springs 64 bias each spoke 52, and thus each segment 38, to rotate about a pivot coupling 66 in an inward direction such that segments 38 can be moved from the docked position in FIG. 1 to the undocked position in FIG. 2, and such that nozzles 42 are pointed inwardly as shown in FIG. 2.

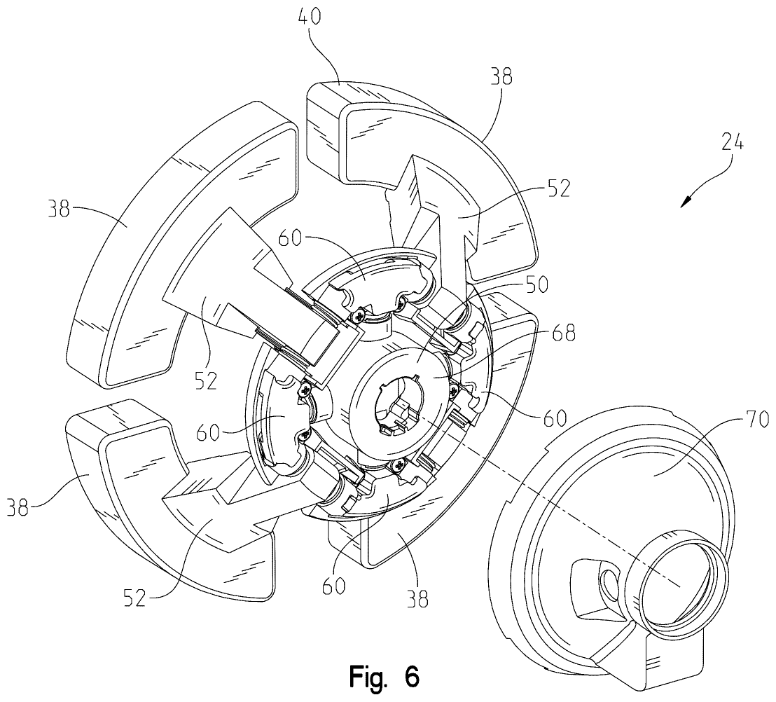

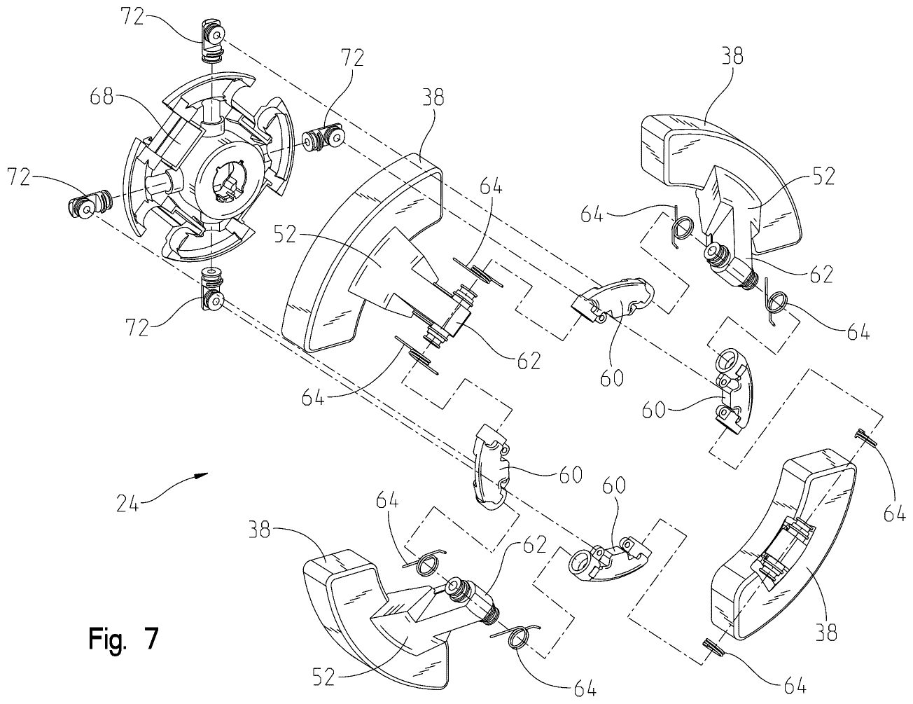

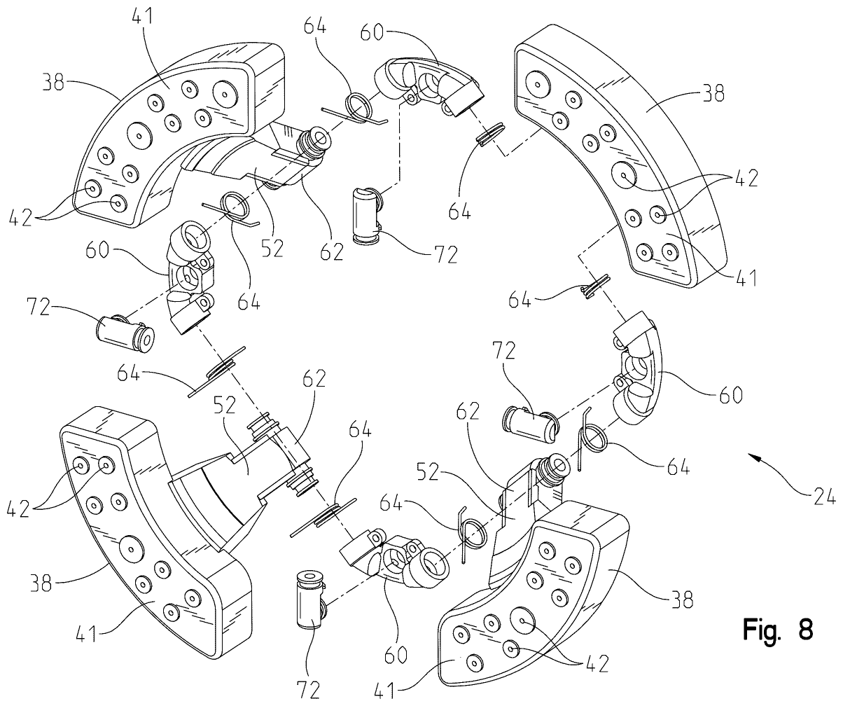

As shown in FIG. 6, hub 50 includes a body 68 and a cap 70. As shown in FIGS. 7 and 8, body 68 of hub 50 is fluidly connected to manifolds 60 by couplers 72. The cap 70 is fluidly coupled to inlet 36.

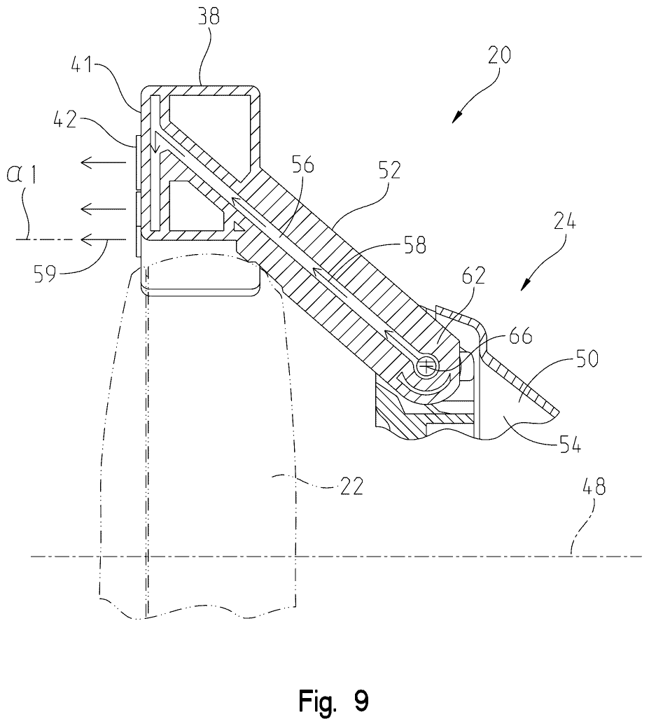

FIG. 9 illustrates segment 38 and spoke 52 in the docked position wherein handshower 22 pushes generally radially outward against segment 38 and against the force of springs 64. In this docked position, nozzles 42 are aimed in a direction substantially parallel to longitudinal axis 41 of converging combination showerhead 20. More particularly, water sprays 59 emitted from the nozzles 42 are discharged at first angle (α1) of approximately 0 degrees relative to the longitudinal axis 48.

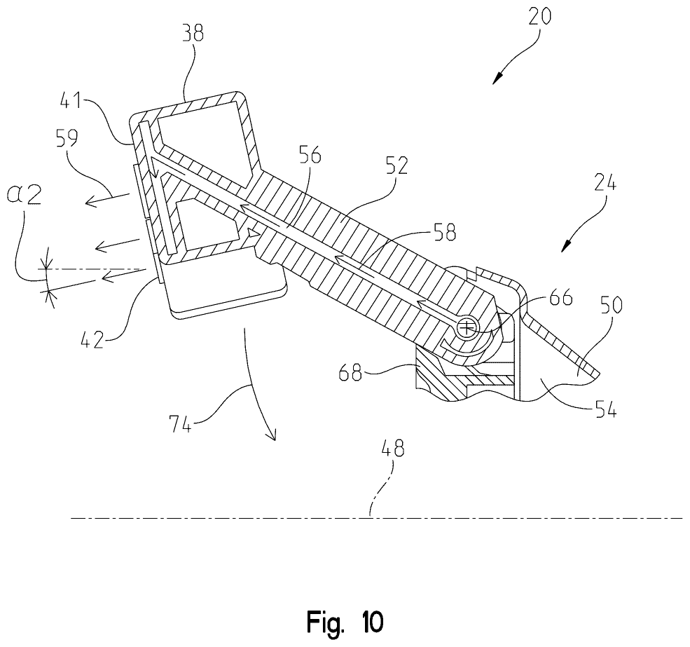

FIG. 10 illustrates segment 38 and spoke 52 in the undocked position wherein handshower 22 has been removed from external showerhead 24. In this undocked position, springs 64 bias segment 38 and spoke 52 in a circumferential direction 74 that is generally radially inward until movement of spoke 52 is stopped or blocked by body 68 of hub 50. In this undocked position, nozzles 42 are aimed in directions generally inward and nonparallel to longitudinal axis 48 of converging combination showerhead 20. More particularly, water sprays 59 emitted from the nozzles 42 are discharged at second angle (α2) relative to the longitudinal axis 48. Second angle (α2) is greater than first angle (α1). Illustratively, second angle (α2) is greater than 0 degrees and less than 90 degrees.

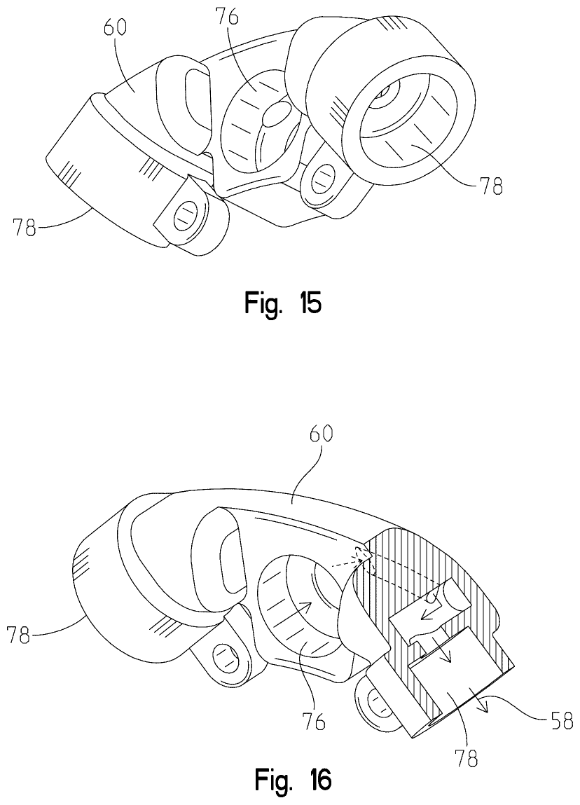

Illustrative manifold 60 is shown in more detail in FIGS. 15-16. Manifold 60 includes an inlet 76 and two opposing outlets 78, with each outlet leading to a different segment 38.

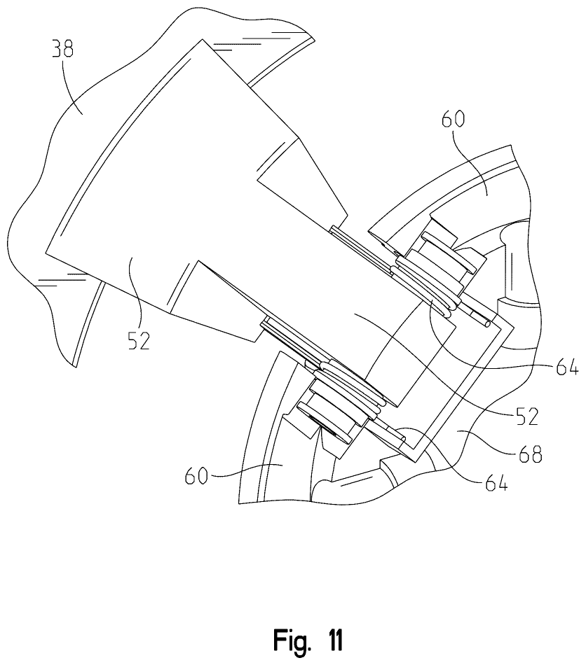

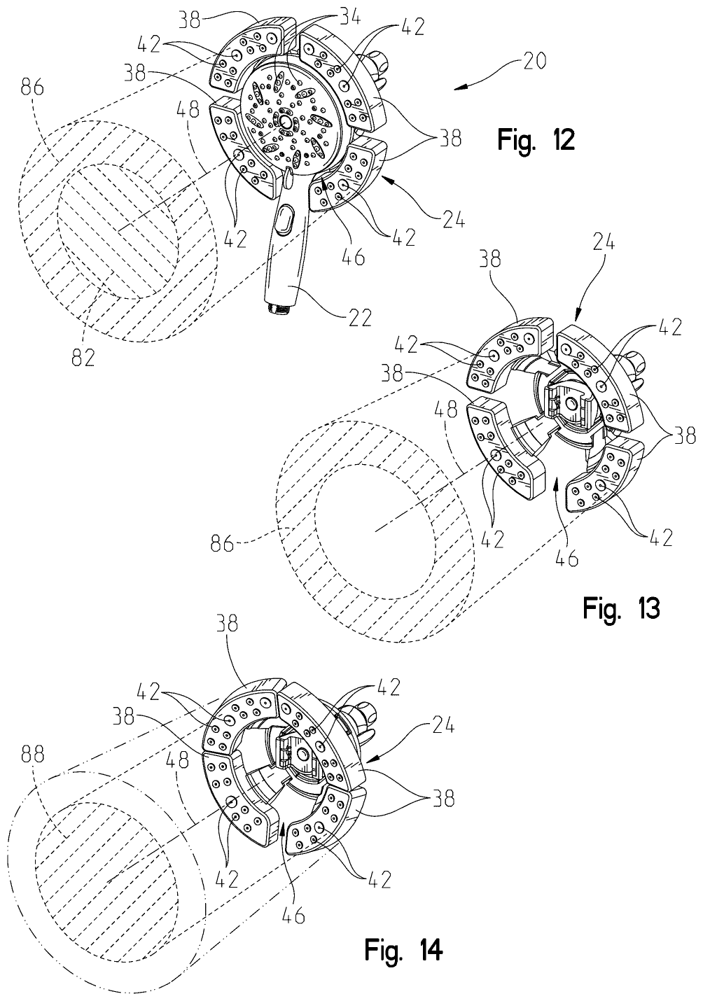

FIG. 12 illustrates the spray coverage of converging combination showerhead 20 when internal handshower 22 is docked in external showerhead 24. Illustrative water spray from internal handshower 22 covers a circular central area 82. Illustrative water spray from external showerhead 24 covers an annular area 88 that surrounds circular central area 82.

FIG. 13 illustrates the spray coverage area 86 of external showerhead 24 of FIG. 12 in isolation and in the absence of the moveable nozzles 42 of the present disclosure. This is the spray coverage area that would be provided in the absence of the moveable nozzles 42 of the present invention when internal handshower 22 is removed and external showerhead 24 remains stationary.

FIG. 14 illustrates a spray coverage area 88 of external showerhead 24 due to the moveable nozzles of the present disclosure after internal handshower 22 has been removed.

With nozzles 42 pointed inwardly due to the bias of springs 64, the water spray 90 from nozzles 42 may be ejected into, and so as to substantially fill, circular central area 88.

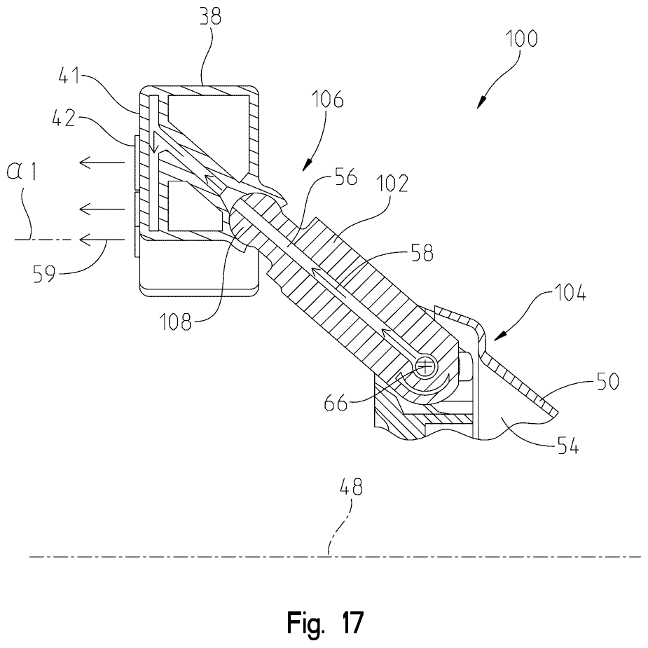

FIGS. 17-19 are cross-sectional views showing a further illustrative shower assembly 100 in different positions, and including many similar features to shower assembly 20 detailed above. As such, in the following description, similar components will be identified with like reference numbers.

Shower assembly 100 includes an arm or spoke 102 having a proximal end 104 rotatably coupled to the hub 50 of the showerhead 24 at first or proximal pivot coupling 66.

Spoke 102 includes a distal end 106 rotatably coupled to segment 38 at a second or distal pivot coupling 108. In FIG. 17, segment 38 is in a first position similar to that shown in FIG. 9 where the handshower 22 is docked to the external showerhead 24. In operation, spoke 102 may rotate about proximal pivot coupling 66 and/or segment 38 may rotate about distal pivot coupling 108. As shown, water sprays 59 emitted from the nozzles 42 are discharged at first angle (α1) of approximately 0 degrees relative to the longitudinal axis 48.

In a first illustrative embodiment, spoke 102 may rotate about proximal pivot coupling 66, while segment 38 remains fixed relative to spoke 102. In a second illustrative embodiment, spoke 102 may rotate about proximal pivot coupling 66, and segment 38 may also rotate about distal pivot coupling 108. In a third illustrative embodiment, spoke 102 may be fixed relative to hub 50, and segment 38 is fixed relative to spoke 102.

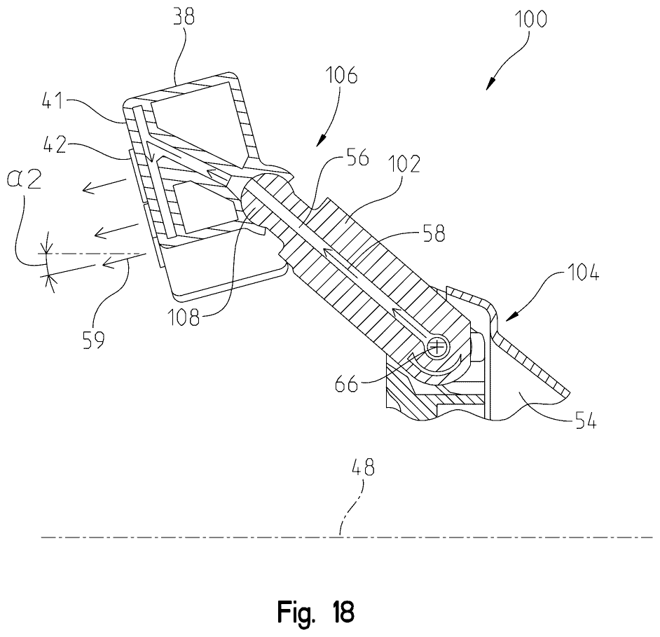

In FIG. 18, segment 38 is in a second position where the handshower 22 is undocked and removed from the external showerhead 24. In this second position, segment 38 pivots inwardly about distal pivot coupling 102. As such, nozzles 38 are aimed in directions generally inward and nonparallel to longitudinal axis 48 of showerhead 100 (similar to the flow shown in FIG. 10). More particularly, water sprays 59 emitted from the nozzles 42 are discharged at second angle (α2) inwardly relative to the longitudinal axis 48. Second angle (α2) is greater than first angle (α1). Illustratively, second angle (α2) is greater than 0 degrees and less than 90 degrees.

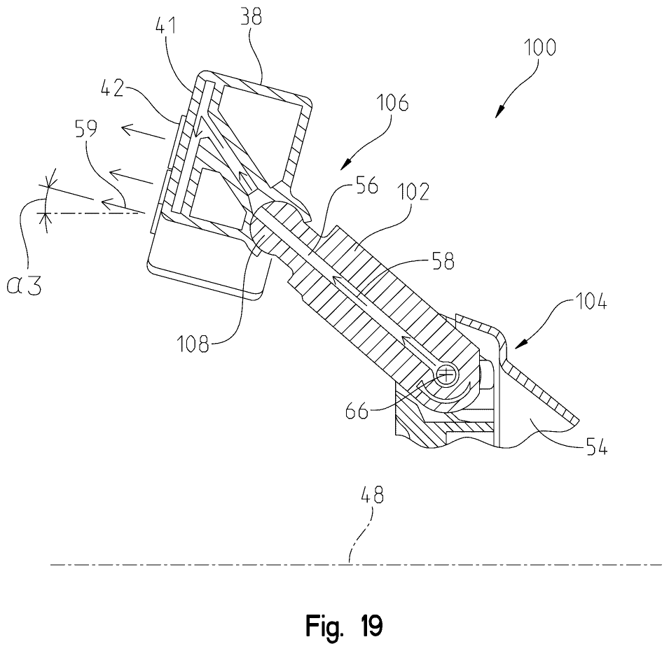

In FIG. 19, segment 38 is in a third position where the handshower 22 is undocked and removed from the external showerhead 24. In this third position, segment 38 pivots outwardly about distal pivot coupling 108. As such, nozzles 42 are aimed in directions generally outward and nonparallel to longitudinal axis 48 of showerhead 100. More particularly, water sprays 59 emitted from the nozzles 42 are discharged at third angle (α3) outwardly relative to the longitudinal axis 48. Third angle (α3) is greater than first angle (α1). Illustratively, third angle (α3) is greater than 0 degrees and less than 90 degrees.

From the aforementioned description, it may be appreciated that illustrative shower assemblies 20 and 100 of the present disclosure are configured to redirect water sprays emitted from the nozzles 42 in response to docking and undocking of handshower 22 relative to showerhead 24. Illustratively, the water sprays 84 are configured to converge or diverge based upon the docking and undocking of handshower 22 relative to showerhead 24.

While the above detailed shower assemblies 20 and 70 illustrate segments 38 that cause corresponding nozzles 42 to rotate for ejecting water in different angular directions relative to longitudinal axis 48, it should be appreciated that in other illustrative embodiments the nozzles 42 may rotate themselves and independently from the respective segments 38. In certain illustrative embodiments, segments 38 and associated faceplates 41 are stationary while nozzles 42 are pivotable. Such nozzles 42 may be biased inwardly toward longitudinal axis 48 when handshower 22 is removed from external showerhead 24. In other illustrative embodiments, both segments 38 and nozzles 42 may move in response to docking and/or undocking handshower 22 from showerhead 24.

In yet other illustrative embodiment shower assemblies, both segments 38 and nozzles 42 remain fixed in position regardless of docking and/or undocking of handshower 22 from showerhead 24. However, the water sprays 84 emitted from the nozzles 42 are still redirected in response to docking and undocking of handshower 22 relative to showerhead 24. In certain illustrative embodiments, nozzles 42 include internal fluidics (flow paths) that may direct sprays between converging and diverging paths as the handshower 22 is docked and undocked from the showerhead 24. In other illustrative embodiments, a first set of nozzles 42 may direct water in a converging path, and a second set of nozzles 42 may direct water in a diverging path, wherein the first set of nozzles 42 and the second set of nozzles 42 are alternatively active (emitting water) depending upon whether the handshower 22 is docked or undocked from the showerhead 24.

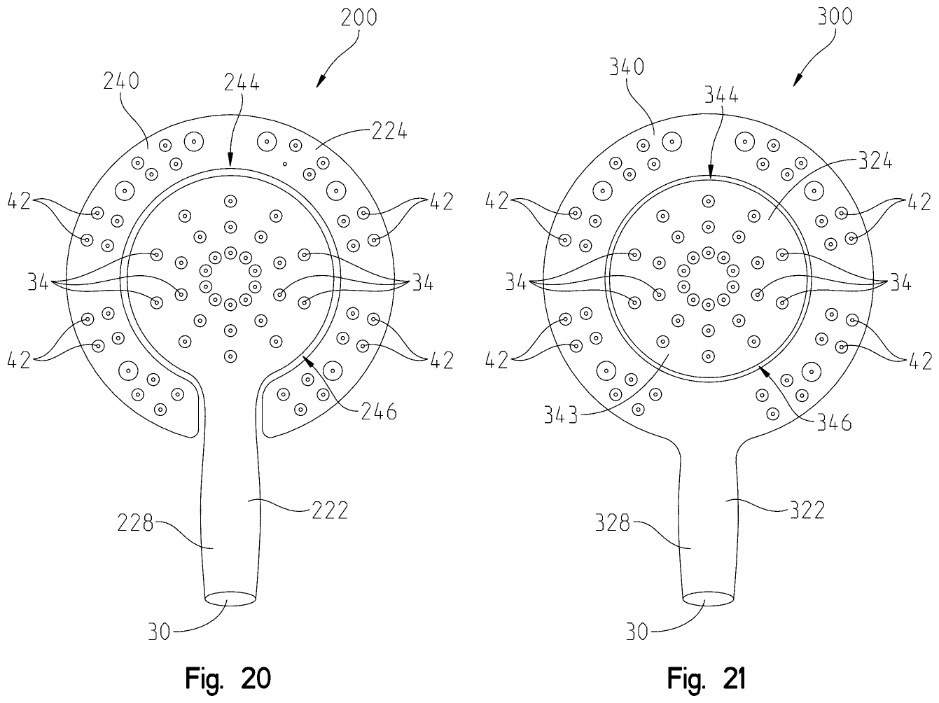

FIGS. 20-23 are diagrammatic views of various illustrative converging combination showerheads 200, 300, 400, 500. The showerheads 200, 300, 400, 500 include many similar features as the showerhead 20 detailed above. As such, in the following description similar components are identified with like reference numbers.

The illustrative showerhead 200 of FIG. 20 includes a fixed or base showerhead 224 including an annular ring 240 having a central gap or opening 246 defining a receiver 244 releasably receiving a handshower 222. The base showerhead 224 illustratively includes fluid outlets 42 movable in response to undocking of the handshower 222. More particularly, the outlets 42 move water sprays emitted therefrom toward the central opening 246 when the handshower 222 is moved from a docked position to an undocked position, and/or when the handshower 222 is returned to the docked position. As further detailed herein, the outlets 42 may move together as groups arranged in faceplate segments (e.g., segments 38 of showerhead 24). Alternatively, each outlet 42 may move (e.g., pivot) individually.

The fluid outlets 34 of the handshower 222 may also be movable to change the direction of water sprays emitted therefrom. Such movement of the fluid outlets 34 may occur when the handshower 222 is moved from a docked position to an undocked position relative to the base showerhead 224, and when the handshower 222 is returned from the undocked position to the docked position relative to the base showerhead 224.

The illustrative showerhead 300 of FIG. 21 includes a fixed or base showerhead 324 including a central outwardly extending protrusion 343 defining a receiver 344. A handshower 322 includes an annular ring 340 having a central gap or recess 346 releasably receiving the protrusion 343 of the base showerhead 324. The fluid outlets 34 of the base showerhead 324 may be movable to change the direction of water sprays emitted therefrom. Such movement of the fluid outlets 34 may occur when the handshower 322 is moved from a docked position to an undocked position relative to the base showerhead 324, and/or when the handshower 322 is returned from the undocked position to the docked position relative to the base showerhead 324.

Similarly, the illustrative handshower 322 may also include fluid outlets 42 movable in response to undocking (and/or docking) of the handshower 322 from the base showerhead 324.

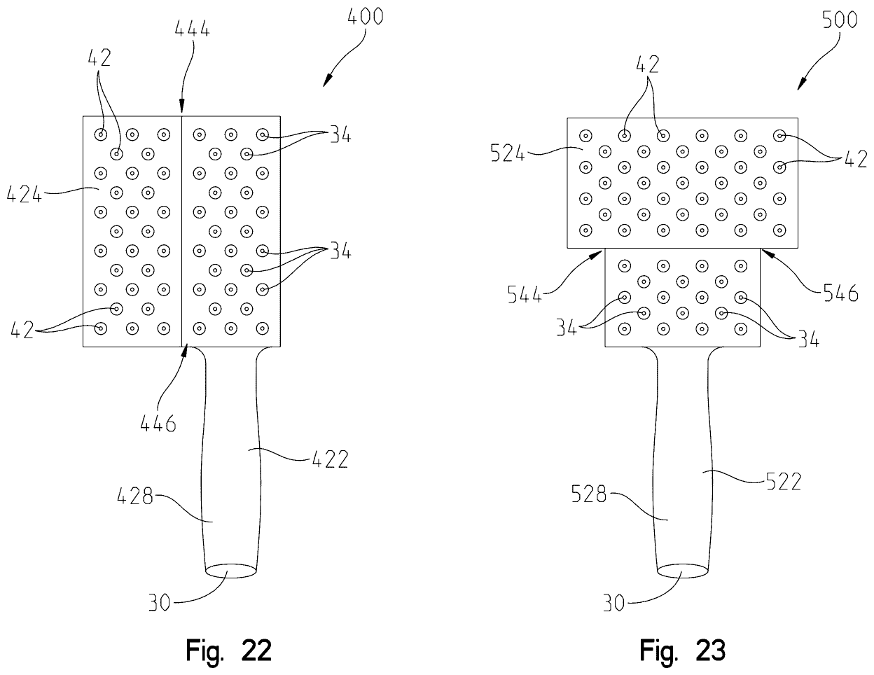

The illustrative showerhead 400 of FIG. 22 includes a handshower 422 vertically aligned with a fixed or base showerhead 424. The base showerhead 424 illustratively includes a vertically extending side gap or opening 446 defining a receiver 444 releasably receiving the handshower 422. The base showerhead 424 illustratively includes fluid outlets 42 movable in response to undocking and/or docking of the handshower 422. More particularly, the outlets 42 move water sprays emitted therefrom toward the opening 446 when the handshower 422 is moved from a docked position to an undocked position, and/or when the handshower 422 is returned from the undocked position to the docked position.

The fluid outlets 34 of the handshower 422 may also be movable to change the direction of water sprays emitted therefrom. Such movement of the fluid outlets 34 may occur when the handshower 422 is moved from a docked position to an undocked position, and when the handshower 422 is returned from the undocked position to the docked position.

The illustrative showerhead 500 of FIG. 23 includes a handshower 522 horizontally aligned with a base showerhead 524. The base showerhead 524 illustratively includes a side gap or opening 546 defining a horizontally extending receiver 544 releasably receiving the handshower 522. The base showerhead 524 illustratively includes fluid outlets 42 movable in response to undocking and/or docking of the handshower 522. More particularly, the outlets 42 move water sprays emitted therefrom toward the opening 546 when the handshower 522 is moved from a docked position to an undocked position, and/or when the handshower 522 is returned from the undocked position to the docked position.

The fluid outlets 34 of the handshower 522 may also be movable to change the direction of water sprays emitted therefrom. Such movement of the fluid outlets 34 may occur when the handshower 522 is moved from a docked position to an undocked position, and when the handshower 522 is returned from the undocked position to the docked position.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A shower assembly comprising:
an external showerhead including a plurality of sections each having a faceplate with a plurality of outlets, the sections defining a central gap therebetween and defining a longitudinal axis, each of the outlets being configured to eject a liquid in a respective direction at a respective angle relative to the longitudinal axis;
a handheld shower removably coupled to the external showerhead in the central gap; and
a plurality of springs configured to bias the sections of the external showerhead against the handheld shower, such that when the handheld shower is removed from the external showerhead, each of the sections of the external showerhead pivot relative to the central gap.

2. The shower assembly of claim 1, wherein when the handheld shower is removed from the external showerhead, the angles between the longitudinal axis and the directions in which the outlets of the external showerhead eject the liquid increase.

3. The shower assembly of claim 1, wherein the springs are configured to pivot the sections of the external showerhead such that the faceplates face more inwardly and more toward the longitudinal axis.

4. The shower assembly of claim 1, wherein the each of the outlets is configured to eject the liquid in a respective direction substantially parallel to the longitudinal axis when the handheld shower is coupled to the external showerhead in the central gap.

5. The shower assembly of claim 1, wherein the sections of the external showerhead comprise at least three circumferentially spaced sections.

6. The shower assembly of claim 1, wherein the handheld shower includes a handle and a head portion coupled to the handle, the head portion having a plurality of nozzles configured to eject a liquid.

7. A shower assembly comprising:
a base showerhead including a plurality of outlets and defining a longitudinal axis, each of the outlets being configured to eject a liquid in a respective direction at a respective angle relative to the longitudinal axis;
a handheld shower removably coupled to the base showerhead; and
wherein the outlets for the base showerhead are configured to pivot relative to the longitudinal axis in response to uncoupling of the handheld shower from the base showerhead.

8. The shower assembly of claim 7, wherein:
the base showerhead includes a plurality of circumferentially spaced sections each having a faceplate with a plurality of the outlets, the sections defining a central gap therebetween and the handheld shower receivable within the central gap; and
each of the sections of the base showerhead are configured to pivot relative to the central gap in response to uncoupling of the handheld shower from the base showerhead.

9. The shower assembly of claim 8, further comprising a plurality of springs configured to bias the sections of the base showerhead against the handheld shower such that when the handheld shower is removed from the base showerhead, each of the sections of the base showerhead pivot, and the faceplates move inwardly and toward the longitudinal axis.

10. The shower assembly of claim 9, wherein the springs are configured to pivot the sections of the base showerhead to increase the angles between the longitudinal axis and the directions in which the outlets eject the liquid.

11. The shower assembly of claim 8, wherein the sections of the base showerhead comprise at least four circumferentially spaced sections.

12. The shower assembly of claim 7, wherein the each of the outlets is configured to eject the liquid in a respective direction substantially parallel to the longitudinal axis when the handheld shower is coupled to the base showerhead.

13. The shower assembly of claim 7, wherein the handheld shower includes a handle and a head portion coupled to the handle, the head portion having a plurality of nozzles configured to eject a liquid.

14. A shower assembly comprising:
a substantially annular external showerhead including a plurality of sections each having a plurality of outlets, the sections defining a central gap therebetween, the outlets being configured to eject a liquid in first directions;
a handheld shower removably coupled to the external showerhead in the central gap; and
a plurality of biasing members configured to bias the sections of the external showerhead against the handheld shower such that when the handheld shower is removed from the external showerhead, each of the sections of the external showerhead pivot such that the outlets eject the liquid in second directions, the second directions being more inward than the first directions relative to the central gap.

15. The shower assembly of claim 14, wherein the biasing members are configured to pivot the sections of the external showerhead such that the faceplates face more inwardly and more toward the longitudinal axis.

16. The shower assembly of claim 14, wherein the each of the outlets is configured to eject the liquid in a respective direction substantially parallel to the longitudinal axis when the handheld shower is coupled to the external showerhead in the central gap.

17. The shower assembly of claim 14, wherein the sections of the external showerhead comprise at least three circumferentially spaced sections.

18. The shower assembly of claim 14, wherein the biasing members comprise springs.

19. A shower assembly comprising:
a base showerhead including a plurality of outlets and defining a receiver and a longitudinal axis;
a handheld shower removably coupled to the base showerhead in the receiver in a first mode;
wherein each of the outlets in the first mode is configured to discharge a liquid in a first direction at a first angle relative to the longitudinal axis; and
wherein the outlets are biased toward the receiver when the handheld shower is removed from the base showerhead in a second mode, such that each of the outlets discharge the liquid in a second direction at a second angle relative to the longitudinal axis.

20. The shower assembly of claim 19, wherein a plurality of springs bias the sections of the base showerhead against the handheld shower.

21. The shower assembly of claim 19, wherein the first angle is substantially parallel to the longitudinal axis, and the second angle is acute relative to the longitudinal axis.

22. The shower assembly of claim 19, wherein the base showerhead includes a plurality of sections each having a faceplate, the faceplates including the plurality of outlets.

23. The shower assembly of claim 22, wherein the base showerhead is an external showerhead, and the sections define a central gap therebetween.

24. The shower assembly of claim 23, wherein in the second mode each of the sections of the external showerhead pivot relative to the central gap.
